(19) United States
(12) Patent Application Publication
(10) Pub. No.: US 2012/0133846 A1
(43) Pub. Date: May 31, 2012

(54) ILLUMINATION DEVICE AND VIDEO PROJECTOR

(75) Inventor: Koji ISHII, Amagasaki-shi (JP)

(73) Assignee: SANYO ELECTRIC CO., LTD., Osaka (JP)

(21) Appl. No.: 13/304,194

(22) Filed: Nov. 23, 2011

(30) Foreign Application Priority Data
Nov. 26, 2010 (JP) 2010-263799

(51) Int. Cl. H04N 9/31; F21V 9/14

(52) U.S. Cl. 348/744; 362/19; 348/E09.025

(57) ABSTRACT

An illumination device includes a light source, which emits light polarized in a single direction, and a beam splitting unit, which splits the polarized light into beams of polarized light at a given ratio. A switching unit switches light converters to convert the polarized light, which is split into a plurality of beams, into beams of colored light. The beams of colored light are combined to change the balance of color purity and light amount of the polarized light.

### CROSS-REFERENCE TO RELATED APPLICATIONS

This application is based upon and claims the benefit of priority from prior Japanese Patent Application No. 2010-263799, filed on Nov. 26, 2010, the entire contents of which are incorporated herein by reference.

### BACKGROUND OF THE INVENTION

The present invention relates to an illumination device that converts light from a light source into light of a plurality of colors and sequentially emits the converted light. The present invention also relates to a video projector using such an illumination device.

Video projectors incorporating a digital micromirror device (DMD), which uses reflective display elements formed by micromirror elements, are known in the art. Such video projectors include an illumination device that sequentially splits, in a time-sharing manner, white light from a light source into light in the red wavelength band (red light), light in the green wavelength band (green light), and light in the blue wavelength band (blue light). Then, the illumination device sequentially emits the split illumination light.

Japanese Laid-Open Patent Publication No. 2004-85813 describes a first prior art example of video projector including such an illumination device. As shown in FIG. 9, the video projector uses an illumination device 110 that separates white light, which is omnidirectional light, from a light source in a time-sharing manner. Then, the illumination device 110 emits the light for each color split from the white light with even brightness. In addition to the illumination device 110, the video projector includes a guide optical system 120, a modulation device 130, and a projection lens 140. The guide optical system 120 guides the light for each color sequentially emitted from the illumination device 110 to a target. The modulation device 130 optically modulates colored illumination light sequentially emitted from the guide optical system 120. The projection lens 140 projects modulated image light.

The illumination device 110 includes a light source 111, which is a white light source that generates omnidirectional white light from a discharge lamp 111a, such as a xenon lamp or an ultra-high pressure mercury lamp. The light source 111 further includes a reflector 111b, which has a parabolic surface. The discharge lamp 111a is arranged at the focal point of the reflector 111b. The light emitted from the discharge lamp 111a is reflected by the reflector 111b and emitted as white spotlight 111c from the light source 111.

The illumination device 110 includes a color wheel 112 that splits the white spotlight 111c emitted from the white light source 111 in a time-sharing manner. The color wheel 112 is a disk rotated about its center. An R filter 112R that passes red light, a G filter 112G that passes green light, and a B filter 112B that passes blue light are sequentially arranged on the disk in the rotation direction. The filters 112R, 112G, and 112B are formed from glass. The white light, or white spotlight 111c, emitted from the light source irradiates the filters 112R, 112G, and 112B. The filtering effect of the filters 112R, 112G, and 112B sequentially extract red light, green light, and blue light, respectively.

The illumination device 110 also includes a rod integrator 113, which is a block of glass or the like. The rod integrator 113 distributes each color of light from the color wheel 112 with an even brightness. The light entering the rod integrator 113 from the color wheel 112 is repetitively reflected by the inner surface of the rod integrator 113. This evens the brightness distribution of the light.

In the video projector that includes the illumination device 110, the guide optical system 120, which guides the light emitted from the illumination device 110, includes condenser lenses 121 and 123 and a full reflection mirror 122. The guide optical system 120 guides the light from the illumination device 110 to the modulation device 130.

The modulation device 130 uses a DMD 131, which is formed by micromirror elements, and an absorber 132 to perform digital optical modulation. Further, the modulation device 130 is provided with image signals synchronized with the red light, green light, and blue light sequentially emitted via the guide optical system 120 from the illumination device 110. The image signal controls the activation and deactivation of the DMD 131 for each color of light, which is optically modulated by controlling a switching ratio. In this manner, the DMD 131 undergoes power width modulation (PWM) control to perform optical modulation.

In the video projector, colored image light, which has been optically modulated as described above, is projected onto a screen from the projection lens 140. The colored image light is combined on the screen into an image that is viewed by an audience.

Japanese Laid-Open Patent Publication No. 2004-325874 (paragraphs 0057 to 0064) describes a second prior art example of a video projector using an illumination device. The video projector includes an excitation light source and a plurality of fluorescent layers. The excitation light source excites the fluorescent layers. The fluorescent layers function as a color wheel and are arranged in the circumferential direction within a certain radius. Further, the fluorescent layers respectively emit red light, blue light, and green light when excited by the light emitted from the light source.

In the illumination device 110 of the first prior art example, the filters 112R, 112G, and 112B respectively extract and pass red light, green light, and blue light from the white light emitted from the light source 111. Thus, when increasing color purity, the illumination device 110 can use only a small amount of the light emitted from the light source 111. In contrast, when increasing the amount of light to increase the brightness, color purity has to be sacrificed. In this manner, color purity and light amount are in a tradeoff relationship.

Further, in the first prior art example, the balance of the color purity and light amount is dependent on the specification of the color wheel 112. In particular, the color purity of a primary color is directly determined by the filtering characteristics of the filters 112R, 112G, and 112B, which form the color wheel 112. Thus, to change the balance of the color purity and light amount, another color filter having different filtering characteristics has to be used.

In the second prior art example, the light emitted from the light source is converted into red light, green light, and blue light by the fluorescent layers arranged on the color wheel. Accordingly, the second prior art example is similar to the first prior art example in that the light amount decreases when increasing the color purity. Further, the balance of the color purity and light amount in the second prior art example is also directly determined by the characteristics of the fluorescent layers arranged on the color wheel. Accordingly, in the second prior art example, to change the balance of the color purity and light amount, another color filter including fluorescent layers with different characteristics has to be used. The second prior art example is also similar in this point to the first prior art example.

Nevertheless, video projectors are required to be versatile and satisfy various demands. For example, a video projector may be used for an application in which color reproducibility is important or an application in which brightness is important. With the first and second prior art examples, the balance of color purity and light amount is directly determined by the color wheel characteristics as described above. Thus, it is difficult for a video projector to meet such different demands.

### SUMMARY OF THE INVENTION

One aspect of the present invention provides an illumination device including a light source that emits polarized light. The light source polarizes the polarized light in a single direction. A light splitting unit splits the polarized light emitted from the light source into beams of polarized light. The light splitting unit is capable of adjusting a splitting ratio of the polarized light. A plurality of light converters respectively convert the beams of polarization light emitted from the light splitting unit into beams of different colored light. A switching unit switches the light converters to simultaneously color-convert, in a predetermined order, the beams of polarized light entering the light converters. A combining unit that combines and emits the beams of colored light that have been simultaneously emitted from the switching unit and color-converted to different colors.

A further aspect of the present invention is a video projector including the illumination device of the first aspect. A modulation device optically modulates the colored light emitted from the illumination device based on an image signal to generate image light. A projection lens enlarges and projects the image light optically modulated by the modulation device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing an illumination device according to a first embodiment of the present invention;

FIG. 2 is a diagram illustrating a light separation effect in the illumination device of the first embodiment;

FIG. 3 is a diagram showing a fluorescent color wheel on the illumination device of the first embodiment;

FIG. 4 is an xy chromaticity diagram for the illumination device of the first embodiment;

FIG. 5 is a schematic diagram of a video projector according to a second embodiment of the present invention;

FIG. 6 is a schematic diagram of a video projector according to a third embodiment of the present invention;

FIG. 7 is a diagram showing an exit side surface of a fluorescent color wheel in the video projector of the third embodiment;

FIG. 8 is a side view showing a modified fluorescent color wheel; and

FIG. 9 is a schematic diagram showing an illumination device and a video projector of the prior art.

### DETAILED DESCRIPTION OF THE INVENTION

### First Embodiment

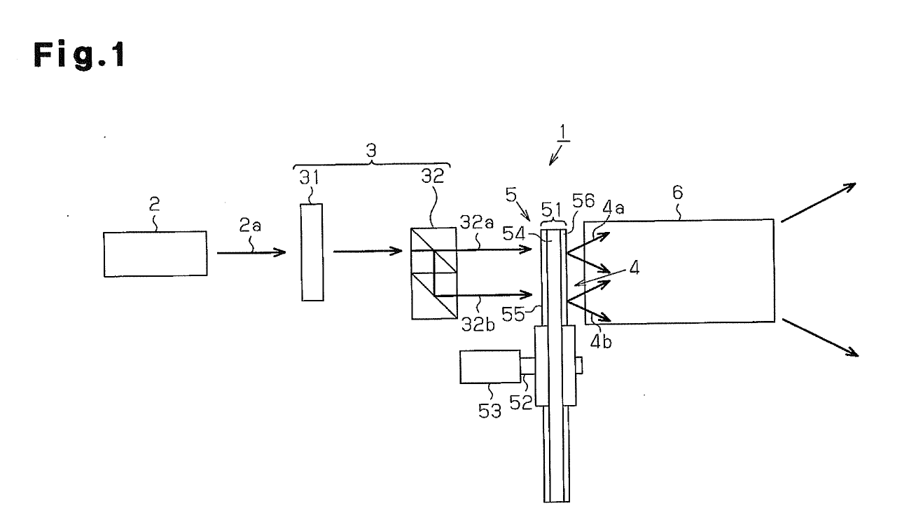

An illumination device 1 according to a first embodiment of the present invention will now be described with reference to FIGS. 1 to 4.

Referring to FIG. 1, the illumination device 1 includes a light source 2, a light splitting unit 3, a light conversion unit 4, a switching unit 5, and a combining unit 6. The light splitting unit 3 splits polarized light emitted from the light source 2 at a given ratio. The light conversion unit 4 includes light converters that convert two beams of polarized light emitted from the light splitting unit 3 into colored light. The switching unit 5 sequentially switches the light converters of the light conversion unit 4. The combining unit 6 combines the beams of colored light sequentially emitted from the switching unit 5 and evens the brightness of the combined light.

The light source 2 may be formed by a semiconductor laser that emits ultraviolet rays forming polarized light 2a polarized in a single direction. The light source 2 may also be formed by a plurality of semiconductor lasers (not shown) that are arranged in an array.

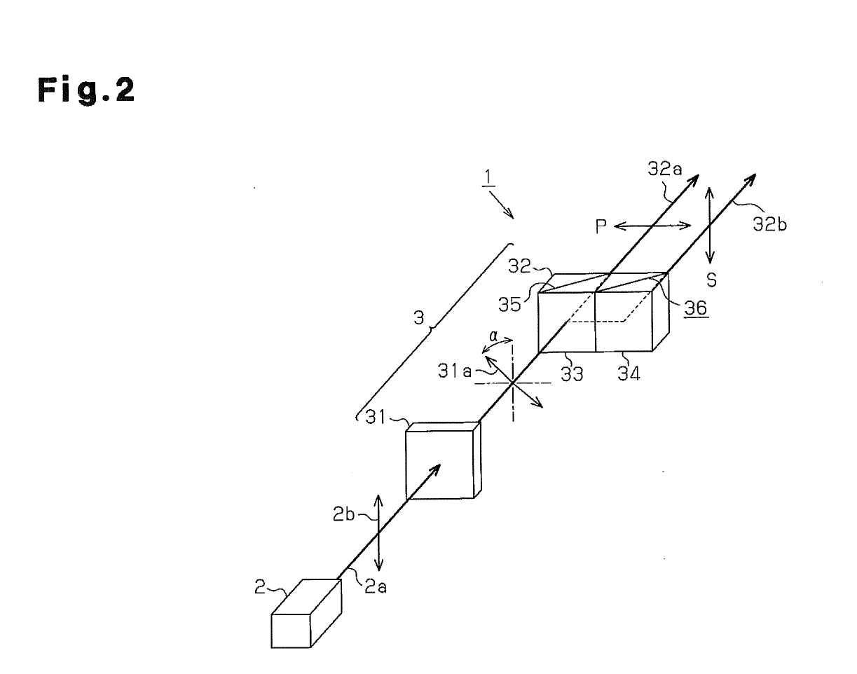

As shown in FIGS. 1 and 2, the light splitting unit 3 includes a polarization rotation element 31 and a polarization beam splitter 32. The polarization rotation element 31 rotates the polarized light 2a emitted from the light source 2 in the single direction, namely, linear polarized light, and emits the rotated light.

The polarization rotation element 31 is preferably a liquid crystal element having a light twisting property, for example, a liquid crystal polarization rotation element formed by a liquid crystal layer in a twisted nematic (TN) mode. The polarized light 2a from the light source 2 enters the liquid crystal polarization rotation element so that a polarization direction 2b of polarized light is parallel to the director of liquid crystal molecules. A polarization direction 31a of the entering polarized light is rotated as shown in FIG. 2 by a liquid crystal layer having a light twisting property. The angle α of the rotation is 90 degrees at maximum but may be adjusted by the voltage applied to the liquid crystal layer. FIG. 2 shows the polarization direction 31a of the rotated polarization light.

The polarization beam splitter 32 splits the entering light into P-polarized light and S-polarized light. As shown in FIGS. 1 and 2, the polarization beam splitter 32 includes two prisms 33 and 34, which form an array. Light enters the prism 33. A thin film 35, which passes P-polarized light and reflects S-polarized light, is applied to the prism 33. The reflected S-polarized light is further reflected toward the exit side by a mirror 36 coupled to the other prism 34. Accordingly, in the polarization beam splitter 32, when the polarization direction 31a of the entering polarized light changes, the ratio of the P-polarization component and S-polarization component in the entering polarized light changes. This changes the ratio of polarized light 32a, which is the exiting P-polarized light, and polarized light 32b, which is the exiting S-polarized light.

Accordingly, the combination of the polarization rotation element 31, which is a liquid crystal polarization rotation element, and the polarization beam splitter 32 splits the polarized light entering the beam splitter 32 into the polarized light 32a, which is P-polarized light, and the polarized light 32b, which is S-polarized light. Further, the rotation angle α of the linear polarized light in the liquid crystal polarization rotation element changes the splitting ratio of the polarized light 32a and 32b. The rotation angle α is adjusted by changing the voltage applied to the liquid crystal polarization rotation element.

The light conversion unit 4 and switching unit 5 will now be described together since they are formed integrally.

The switching unit 5 is configured to sequentially switch the light converters of the light conversion unit 4. More specifically, the switching unit 5 is formed by a so-called color wheel 51. As shown in FIG. 1, a rotation shaft 52 extends through the center of the switching unit 5. The rotation shaft 52 is rotated by a motor 53. The light conversion unit 4 converts polarized light into a predetermined color of light and may be formed by color filters, which are formed from glass and selectively pass colored light having predetermined wavelengths, or fluorescent layers, which generate different predetermined colors of light when excited by the irradiation of exciting light such as ultraviolet light. In this embodiment, the light conversion unit 4 includes fluorescent layers.

As shown in FIG. 1, the fluorescent color wheel 51 includes a transparent substrate 54, a visible light reflection film 55, which is applied to the entrance side surface of the transparent substrate 54, and a fluorescent layer 56, which is applied to the exit side surface of the transparent substrate 54.

The transparent substrate 54 is formed from a transparent material having an optical characteristic that passes the ultraviolent light from the semiconductor laser of the light source 2. For example, the transparent substrate 54 is preferably formed from phased silica or silica glass.

The visible light reflection film 55 passes ultraviolet light and reflects visible light. The visible light reflection film 55 is preferably a cold mirror, which reflects ultraviolet light, or a band pass filter, which is formed by a dielectric multilayer film.

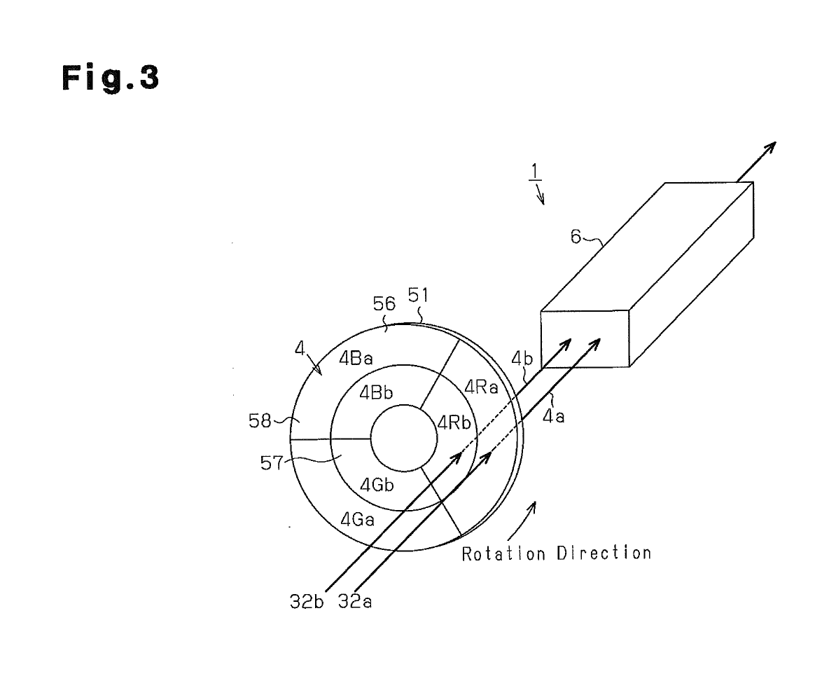

The fluorescent layer 56 is a wavelength conversion layer that converts ultraviolet light into visible light having a predetermined color. Further, the fluorescent layer 56 is divided into an inner region 57 and an outer region 58. As shown in FIG. 3, the outer region 58 is irradiated with the polarized light 32a emitted from the switching unit 5. The inner region 57 is irradiated with the polarized light 32b, which is spotlight. FIG. 3 schematically shows only the fluorescent layer 56 that is arranged at the exit side of the fluorescent color wheel 51.

In the fluorescent layer 56, the inner region 57, which is irradiated with the spotlight, and the outer region 58 are divided into three by bounding lines extending in the radial direction at equal angular intervals. Thus, the fluorescent layer 56 is divided into a total of six sections. The divided sections of the fluorescent layer 56 form light converters 4Ra, 4Ga, 4Ba, 4Rb, 4Gb, and 4Bb. To convert excitation light from the light source 2 to predetermined colors of light, the light converters 4Ra, 4Ga, 4Ba, 4Rb, 4Gb, and 4Bb are formed by mixing various types of fluorescent substances with a synthetic resin solution at a predetermined concentration and mixing ratio. The compound is then applied to the exit side surface of the transparent substrate 54 with a predetermined thickness and dried.

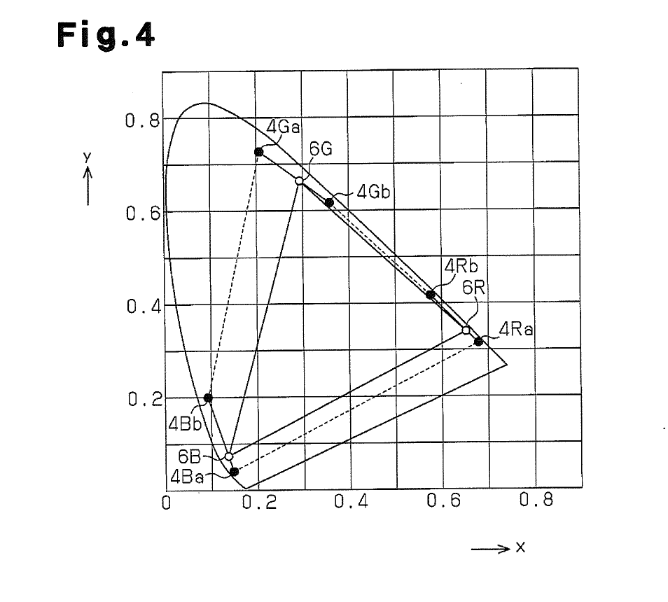

In the fluorescent layer 56, the paired sections of the inner region 57 and the outer region 58 are formed to emit colored light having the same chromaticity. More specifically, the light converters 4Ra and 4Rb are formed for red light, the light converters 4Ga and 4Gb are formed for green light, and the light converters 4Ba and 4Bb are formed for blue light. The chromaticity of light converted by the light converters is set by the stimulus values shown in the xy chromaticity diagram of FIG. 4. Fluorescent layers for the primary colors of light, namely, red light, green light, and blue light, are arranged in the light converters 4Ra, 4Ga, and 4Ba of the outer region 58. Fluorescent layers for color adjustment of the primary colors of light are arranged in the light converters 4Rb, 4Gb, and 4Bb of the inner region 57.

The light conversion unit 4 and the switching unit 5 are formed in this manner. Thus, the polarized light 32a and 32b split by the light splitting unit 3 enters the outer region 58 and inner region 57 of the switching unit 5. Then, red light, green light, and blue light are sequentially color-converted in a time-sharing manner to emit the colored light 4a and 4b to the combining unit 6.

The combining unit 6 combines the colored light 4a and 4b of different colors emitted in a time-sharing manner from the switching unit 5. To even the brightness distribution, the combining unit 6 is formed by a rod integrator, which is a transparent block of glass or the like. As described above, the two beams of light 4a and 4b, which have been converted into colored light of a predetermined chromaticity, from the switching unit 5 enter the combining unit 6 in a time-sharing manner. The two beams of light 4a and 4b are repetitively reflected and combined by the inner surface of the rod integrator and then emitted as light having an even brightness distribution. Accordingly, the light from the illumination device of the present embodiment is emitted in a time-sharing manner with the chromaticity of the stimulus values 6R, 6G, or 6B shown in the xy chromaticity diagram of FIG. 4.

The operation of the illumination device of the first embodiment will now be described.

The polarization rotation element 31 of the light splitting unit 3 rotates the white laser light polarization direction 2b of the polarized light 2a emitted in a single direction from the light source 2. The rotation angle α of the rotated polarization direction 31a changes the light amount of the P-polarized light and the S-polarized light entering the polarization beam splitter 32, which forms the light splitting unit 3. This changes the splitting ratio of the polarized light 32a for the P-polarization components and the polarized light 32b for the S-polarization components that are separated by the polarization beam splitter 23. The rotation angle α of the polarization direction 31a in the polarization rotation element 31 is adjusted by changing the voltage applied to a liquid crystal layer with a control signal of the illumination device 1. When the illumination device 1 is used for a video projector, the illumination device 1 is an image signal. Further, the user can change the voltage applied to the liquid crystal layer to adjust the chromaticity of the illumination light to a preferred level.

In this manner, the polarized light 32a and 32b, each of which is a spotlight obtained by dividing light into two with the light splitting unit 3, enter predetermined locations of the inner region 57 and outer region 58 of the fluorescent color wheel 51 functioning as the switching unit 5, which is sequentially switched by the light conversion unit 4, namely, the light converters 4Ra, 4Ga, 4Ba, 4Rb, 4Gb, and 4Bb. The spotlight passes through the transparent substrate 54 and the visible light reflection film 55 to irradiate the fluorescent layer 56, which includes the light converters 4Ra, 4Ga, 4Ba, 4Rb, 4Gb, and 4Bb. This excites the fluorescent layer 56 and emits omnidirectional light for a predetermined color. The colored light emitted from the fluorescent layer 56 toward the entrance side is reflected by the visible light reflection film 55 toward the exit side. Thus, most of the converted light is emitted toward the exit side.

The two beams of polarized light 32a and 32b entering the switching unit 5 irradiate the light conversion unit 4. The light conversion unit 4 rotates the fluorescent color wheel 51. This sequentially switches the light converters 4Ra and 4Rb, which emit red light, to the light converters 4Ga and 4Gb, which emit green light, and then to the light converters 4Ba and 4Bb. Accordingly, the two beams of the light 4a and 4b emitted from the switching unit 5 are sequentially switched to two beams of red light (stimulus values of 4Ra and 4Rb), two beams of green light (4Ga and 4Gb), and then two beams of blue light (stimulus values of 4Ba and 4Bb). In other words, the beams of the light 4a and 4b are emitted to the combining unit 6 in a time-sharing manner.

The two beams of colored light 4a and 4b emitted to the combining unit 6 are combined by the rod integrator, which forms the combining unit 6. Thus, the combining unit 6 combines the two beams of light 4a and 4b while sequentially converting their chromaticity to the stimulus values indicated by 6R, 6G, and 6B in the xy chromaticity diagram. In this case, the light emitted from the rod integrator is colored light having an even brightness distribution.

The illumination device 1 of the first embodiment has the advantages described below.

(1) The light splitting unit 3 adjusts the splitting ratio of the polarized light. This adjusts the chromaticity of the illumination light emitted from the illumination device 1 to any chromaticity between the chromaticity of each of the mixed light 4a and 4b. Accordingly, the illumination device 1 sequentially emits single color light, namely, red light, green light, and blue light, in a time-sharing manner.

(2) The light source 2 is formed by a semiconductor laser. Thus, the polarized light 2a, the polarization direction 2b of which is oriented in a single direction, is emitted with a simple configuration.

(3) The light splitting unit 3 is formed by combining the polarization rotation element 31 and the polarization beam splitter 32. The polarization beam splitter 32 rotates the polarized light 2a, which is emitted in a single direction from the light source 2, in a given polarization direction 31a and emits the rotated polarized light 2a. The polarization beam splitter 32 splits the entering polarized light with into two beams of polarized light having a different ratio in accordance with the polarization direction 31a. Accordingly, by changing the rotation direction a of the polarization direction 31a of the polarized light with the polarization rotation element 31, the polarization beam splitter 32 can easily change the splitting ratio of the two beams of polarized light 32a and 32b.

(4) The polarization rotation element 31 is formed by a liquid crystal element having a TN mode and thus has a light twisting property. Further, the polarization rotation element 31 adjusts the voltage applied to the liquid crystal element by adjusting the polarization direction 31a. Thus, the polarization rotation element electrically adjusts the rotation angle α of the polarization direction 31a. Accordingly, the illumination device 1 and a controller for a device to which the illumination device 1 is applied are simplified.

(5) The light source 2 emits ultraviolent light. The light conversion unit 4 includes the fluorescent layer 56, which is excited when the light conversion unit 4 is irradiated by ultraviolet light. The switching unit 5 includes the transparent substrate 54, which has the form of a rotation wheel. Plural sections of the light conversion unit 4 formed by fluorescent layers that emit different colors of light are arranged on the exit side surface of the transparent substrate 54 in a predetermined order. Accordingly, when the split polarized light 32a and 32b from the light source 2 irradiates the switching unit 5, the polarized light 32a and 32b sequentially irradiates the fluorescent layers of the light converters 4Ra, 4Ga, 4Ba, 4Rb, 4Gb, and 4Bb arranged in a predetermined order. This sequentially emits colored light of a predetermined chromaticity. The switching unit 5 is formed as a rotation wheel and thus easily processes light in a time-sharing manner.

(6) The switching unit 5 divides the exit side surface of the rotation wheel into the outer region 58 and the inner region 57. The outer region 58 is separated into fluorescent layers for the primary colors of light for red, green, and blue. The inner region 57 includes fluorescent layers for color adjustment of the primary colors. Accordingly, with respect to the rotation of the rotation wheel, the occupying ratio of the primary colors of red light, green light, and blue light does not decrease. Thus, even an image using many primary colors can be brightened.

(7) The combining unit 6 is a light guide that combines the colored light 4a and 4b, which are sequentially emitted from the switching unit 5 with a different chromaticity and evens the brightness distribution. Thus, illumination light can be emitted with an even brightness distribution.

### Second Embodiment

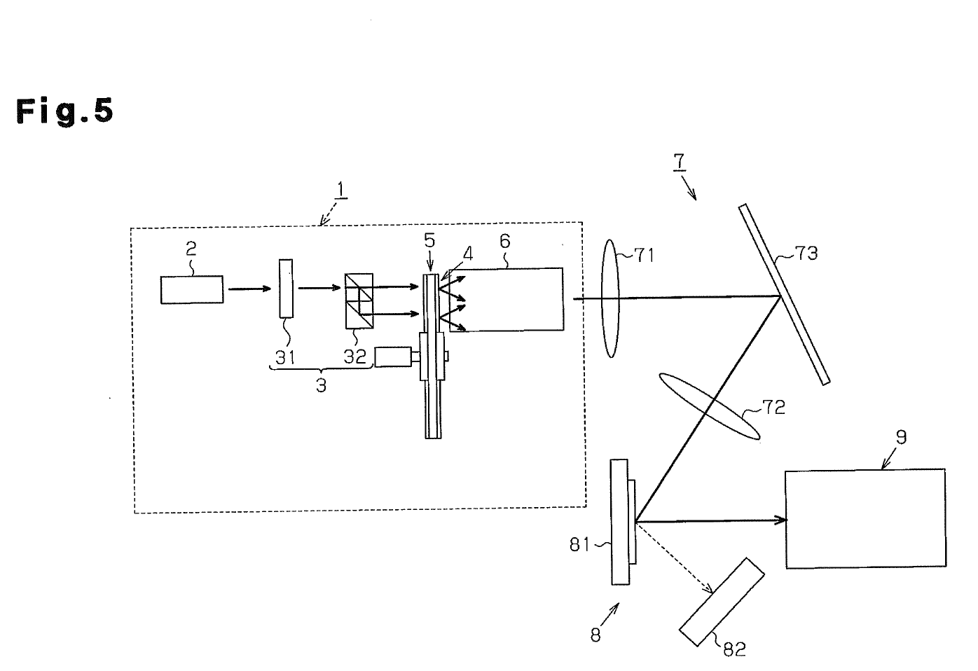

A second embodiment will now be described with reference to FIG. 5.

In the second embodiment, a video projector uses the illumination device of the first embodiment. To avoid redundancy, like or same reference numerals are given to those components that are the same as the corresponding components of the first embodiment. Such components will now be described.

In the present embodiment, the video projector includes the illumination device 1 of the first embodiment, a guide optical system 7, a modulation device 8, and a projection lens 9. The guide optical system 7 guides colored light emitted from the illumination device 1 to the modulation device 8. The modulation device 8 optically modulates the colored light based on the image signal. The projection lens 9 enlarges and projects image light, which is modulated by the modulation device 8.

The guide optical system 7 includes condenser lenses 71 and 72 and a full reflection lens 73. Further, the guide optical system 7 guides the colored light emitted from the illumination device 1 to the modulation device 8.

The modulation device 8 uses a digital micromirror device (DMD) 131, which is formed by micromirror elements, and an absorber 82 to perform digital optical modulation.

The DMD 81 is an integrated semiconductor optical switch including about 500,000 to 1,300,000 micromirror elements arranged in a matrix. The micromirror elements of the DMD 81 are arranged in correspondence with pixels in an image frame. Further, the micromirror elements of the DMD 81 are supported so that their inclination angles can be varied by approximately ±10 degrees in an activated state and a deactivated state. When the micromirror elements are activated, the light reflected by the micromirror elements is projected onto a screen (not shown) through the projection lens 9. When the micromirror elements are deactivated, the light reflected by the micromirror elements is absorbed by the absorber 82, which is arranged in a direction inclined by approximately 20 degrees from a light beam in an activated state.

In the DMD 81, the activation and deactivation of the micromirror elements and the control of the switching ratio are synchronized with the red light, green light, and blue light sequentially sent from the illumination device 1 by the fluorescent color wheel 51. In this manner, the DMD 81 undergoes PWM control.

The projection lens 9 enlarges the reflected emitted light when the micromirror elements of the DMD 81 are activated and projects the enlarged emitted light onto a projection surface (not shown) such as a screen. In the projection lens 9, lenses are combined to reduce the lens aberration. Further, the optical axis of the projection lens 9 is aligned with the optical axis of light emitted from the micromirror elements when light beams are emitted toward the front from the activated micromirror elements.

The operation of the video projector will now be described.

The illumination light emitted from the illumination device 1 is guided to the DMD 81 of the modulation device 8 via the condenser lenses 71 and 72 and the full reflection lens 73 and optically modulated in accordance with an image signal. Here, the fluorescent color wheel 51 and the DMD 81 are synchronously controlled. Thus, when the fluorescent color wheel 51 is rotated, the light converters 4Ra, 4Ga, 4Ba, 4Rb, 4Gb, and 4Bb are switched. When the DMD 81 is irradiated with colored light, the DMD 81 also sequentially switches and displays the image of the colored light. Further, the polarization rotation element 31, which is formed by a liquid crystal polarization rotation element, is synchronously controlled to obtain the optimal color purity in accordance with each image mode or each scene. The modulated light (i.e., image light) emitted from the DMD 81 is enlarged by the projection lens 9 and projected onto a screen (not shown).

The video projector of the second embodiment has the advantages described below.

The video projector uses the illumination device 1, which dynamically changes the balance of a single color purity and light amount. Thus, the color reproducibility of a projected image can be improved.

The voltage applied to the liquid crystal polarization rotation element of the polarization rotation element 31 is adjusted by an image signal to change the balance of color purity and light amount for the illumination device 1. This allows the video projector to display an image within a wide range in the xy chromaticity diagram. Thus, the video projector provides an image having high color reproducibility.

### Third Embodiment

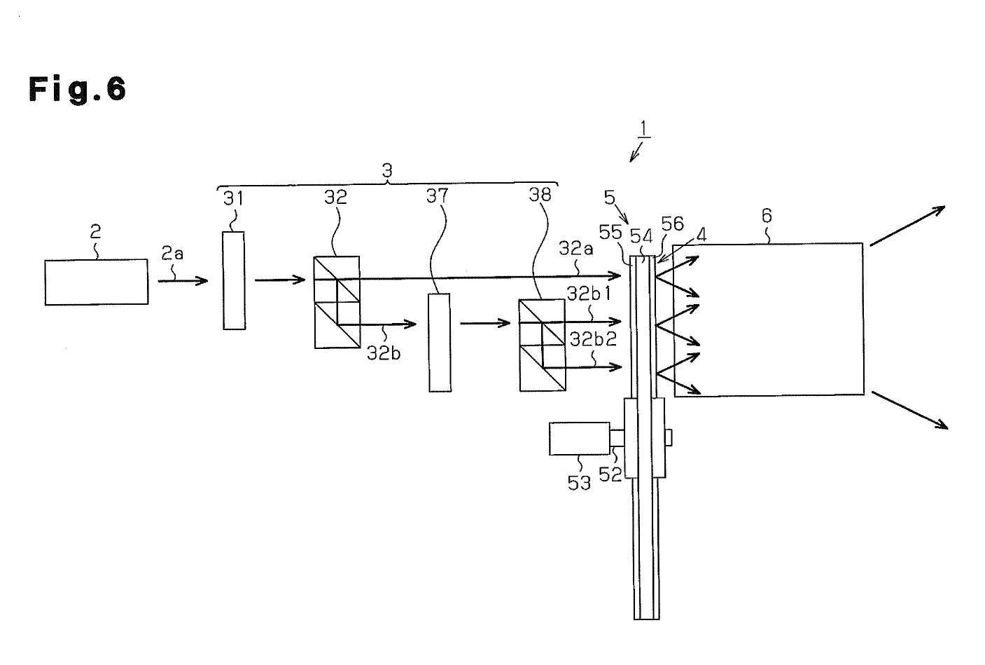

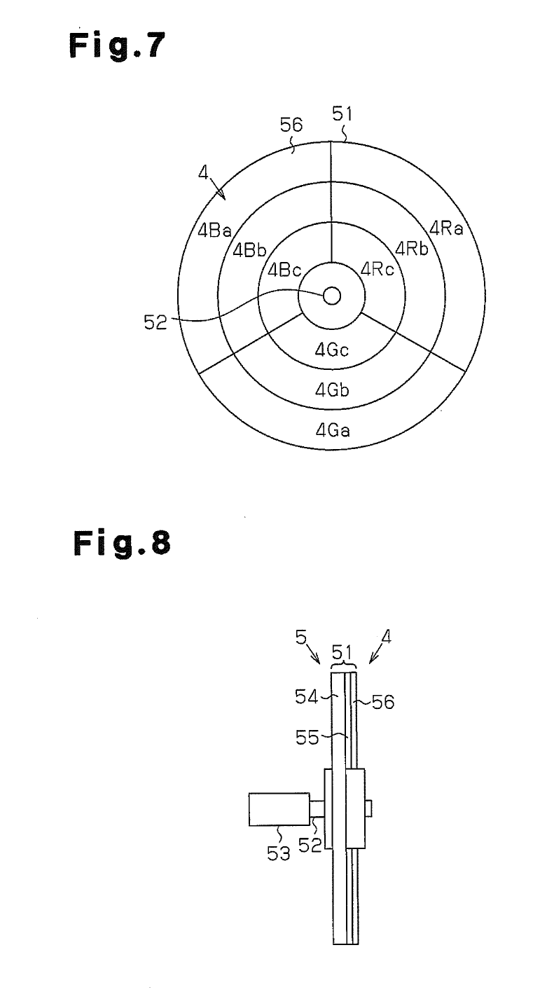

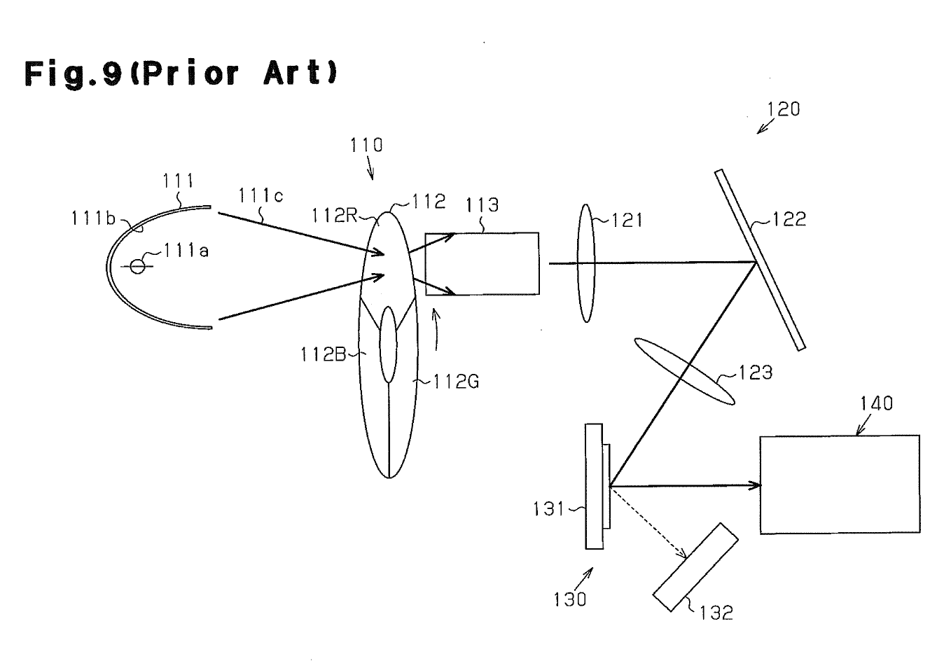

An illumination device of the third embodiment differs from the illumination device 1 of the first embodiment in that the polarized light 2a emitted from a light source is split into three by a given ratio. The illumination device of the present embodiment will now be described with reference to FIGS. 6 and 7. To avoid redundancy, like or same reference numerals are given to those components that are the same as the corresponding components of the first embodiment. Such components will not be described.

Referring to FIG. 6, in the same manner as the first embodiment, the light splitting unit 3 includes a polarization rotation element 31 and the polarization beam splitter 32. The polarization rotation element 31 rotates the polarized light 2a emitted from the light source 2 in a single direction to a given polarization direction. The polarized light of which polarization direction has been changed by the polarization rotation element 31 is split into two by the polarization beam splitter 32. In this embodiment, among the two beams of the polarized light 32a and 32b emitted from the polarization beam splitter 32, to split the polarized light 32b (in this case, S-polarized light) into two with a further given ratio, the light splitting unit 3 includes a polarization rotation element 37, which is arranged along an optical path of the polarized light 32a, and a polarization beam splitter 38.

With this configuration, due to the same principle as the first embodiment, the polarized light 32b is split by a given splitting ratio into two, namely, polarized light 32b1 and polarized light 32b2. As a result, the polarized light 2a of a single direction emitted from the light source 2 is split into three by a given splitting ratio.

To convert the light that is split into three, namely, the polarized light 32a, 32b1, and 32b2, into light of a different color, the fluorescent layer 56 of the fluorescent color wheel 51 in the first embodiment is separated into three layers in the radial direction. The three layers are further equally separated in the circumferential direction into three sections. These sections form light converters 4Ra, 4Ga, 4Ba, 4Rb, 4Gb, 4Bb, 4Rc, 4Gc, and 4Bc.

The illumination device of the third embodiment has the advantages described below.

In comparison with the illumination device of the third embodiment, the illumination device of the third embodiment can be used for colored light with more chromaticity. Thus, illumination light can be emitted with finer color purity. Accordingly, a video projector using the illumination device of the third embodiment provides an image having high color reproducibility.

It should be apparent to those skilled in the art that the present invention may be embodied in many other specific forms without departing from the spirit or scope of the invention. Particularly, it should be understood that the present invention may be embodied in the following forms.

In the above embodiments, a semiconductor laser that emits polarized light having a single wavelength is used as the light source 2. However, the present invention is not limited in such a manner. For example, a white light source including a discharge lamp that generates omnidirectional light may be used. In this case, however, the light emitted from the light source is required to be changed to polarized light in a single direction by a polarization conversion element.

The polarization rotation element 31 is not limited to a liquid crystal rotation display element and other elements may be used instead.

In the above embodiments, the polarized light 2a emitted from the light source 2 is split into two or three but may be split into four or more under the same principle.

In the above embodiments, a fluorescent layer is used as the light conversion unit 4. Instead, a color filter formed from glass that selectively passes colored light of a predetermined wavelength as described above may be used.

In the fluorescent color wheel 51, instead of the entering side surface of the transparent substrate 54, the visible light reflection film 55 may be formed on the exit side surface of the transparent substrate 54, as shown in FIG. 8. Further, the fluorescent layer 56 may be formed on the exit side surface of the visible light reflection film 55. In such cases, the illumination device would have the same advantages as the above embodiments.

In lieu of the rod integrator, a tubular light tunnel having a tetragonal cross-section and a mirror formed on its inner surface may be used as the combining unit 6. In this case, the illumination device would have the same advantages as the above embodiments. Further, the combining unit 6 may just combine light for a plurality of colors. In this case, the combining unit 6 does not even the brightness distribution of colored light.

In an illumination device according to the present invention, the guide optical system 7 of the second embodiment may be used in the other embodiments described above.

In the above embodiments, the DMD 81, which is a reflective display element, is used as the modulation device 8. Instead, light modulation may be performed by a transmissive liquid crystal element or the like.

In the second embodiment, the balance of color purity and light amount for each screen is adjusted by the voltage applied to the liquid crystal polarization rotation element based on the image signal. However, the balance may be manually adjusted by a user. This adjusts the color reproducibility and brightness in accordance with application or the user's preference.

The present examples and embodiments are to be considered as illustrative and not restrictive, and the invention is not to be limited to the details given herein, but may be modified within the scope and equivalence of the appended claims.

1. An illumination device comprising:
a light source that emits polarized light, wherein the light source polarizes the polarized light in a single direction;
a light splitting unit that splits the polarized light emitted from the light source into beams of polarized light, wherein the light splitting unit is capable of adjusting a splitting ratio of the polarized light;
a plurality of light converters that respectively convert the beams of polarization light emitted from the light splitting unit into beams of different colored light;
a switching unit that switches the light converters to simultaneously color-convert, in a predetermined order, the beams of polarized light entering the light converters; and
a combining unit that combines and emits the beams of colored light that have been simultaneously emitted from the switching unit and color-converted to different colors.

2. The illumination device according to claim 1, wherein the light source includes a semiconductor laser.

3. The illumination device according to claim 1, wherein the beam splitting unit includes at least a combination of:
a polarization rotation element that rotates the polarization direction of the polarized light emitted from the light source, wherein the polarization rotation element is capable of adjusting a rotation angle of the polarization direction; and
a polarization beam splitter that splits the polarization light from the polarization rotation element into two beams of polarization light at a ratio corresponding to the polarization direction of the polarization light.

4. The illumination device according to claim 3, wherein the polarization rotation element is formed by a liquid crystal element having a light twisting property, and the polarization rotation element adjusts the polarization direction of the polarization light from the light source in accordance with voltage applied to the liquid crystal element.

5. The illumination device according to claim 1, wherein
the light source emits ultraviolet light,
the light converters each include a fluorescent layer excited by the ultraviolent light emitted from the light source to emit a beam of colored light having a predetermined chromaticity,
the switching unit has the shape of a rotation wheel and includes a transparent substrate having an exit side surface that emits the colored light, and
the light converters that emit the beams of colored light having different chromaticity are arranged on the exit side surface of the transparent substrate and are arranged in a circumferential direction in a predetermined order.

6. The illumination device according to claim 5, wherein
the switching unit includes an outer region and an inner region, and
the light converters including fluorescent layers for the primary colors of light, which are red light, green light, and blue light, are arranged in the outer region, and light converters that adjust colors of the beams of colored light emitted from the light converters are arranged in the inner region.

7. The illumination device according to claim 1, wherein the combining unit includes a light guide that combines the beams of colored light having different chromaticity sequentially emitted from the switching unit, wherein the light guide evens a brightness distribution of the colored light.

8. A video projector comprising:
the illumination device according to claim 1;
a modulation device that optically modulates the colored light emitted from the illumination device based on an image signal to generate image light; and
a projection lens that enlarges and projects the image light optically modulated by the modulation device.

9. The video projector according to claim 8, wherein
the polarization rotation element is formed by a liquid crystal element having a light twisting property, and the polarization rotation element is capable of adjusting the polarization direction of the polarization light from the light source in accordance with voltage applied to the liquid crystal element, and
the voltage applied to the liquid crystal element is changed in accordance with the image signal.

10. The video projector according to claim 8, wherein
the polarization rotation element is formed by a liquid crystal element having a light twisting property, and the polarization rotation element is capable of adjusting the polarization direction of the polarized light from the light source in accordance with voltage applied to the liquid crystal element, and
the video projector further includes an operation unit operated by an operator to change the voltage applied to the liquid crystal element.
